(19) United States
(12) Patent Application Publication
(10) Pub. No.: US 2008/0222452 A1
(43) Pub. Date: Sep. 11, 2008

(54) TEST APPARATUS FOR TESTING A CIRCUIT UNIT

(75) Inventor: HANS-GERD KIRCHHOFF, Ratingen (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/689,970

(22) Filed: Mar. 22, 2007

(30) Foreign Application Priority Data
Mar. 8, 2007 (DE) 10 2007 011 437.2

(51) Int. Cl. G06F 11/00

(52) U.S. Cl. 714/27; 714/30

(57) ABSTRACT

Test apparatus for testing a circuit unit. A first test device is arranged outside the circuit unit. A second test device, which is arranged integrally with the circuit unit, has a sample-and-hold unit for sampling at least one voltage value of an output signal output from the circuit unit and for holding the sampled voltage value, and a logic unit for driving the sample-and-hold unit. The voltage value sampled by the second test device is fed to the first test device as a test result signal.

### CROSS-REFERENCE TO RELATED APPLICATION

This application claims priority to German Patent Application Serial No. 10 2007 011 437.2, which was filed Mar. 8, 2007, and is incorporated herein by reference in its entirety.

### TECHNICAL FIELD

The present invention generally relates to test circuits for testing electronic driver units. In particular, the present invention relates to test circuits for testing electronic driver units which are designed for high data transmission speeds.

Driver units, in particular high-speed driver units, are required for example at the transmitter end of many interface units such as intrachips, multichips, broad level units or system level units. Specific requirements are made of the drivers with regard to transmission amplitude, transmission frequency and edge steepness. As an example of drivers of this type, use is made of, for example, the Universal Serial Bus (USB), IBEB1394 (Firewire), VDLS, Write-Channel, SDI (Serial Digital Interface) etc. in conventional circuit arrangements. Furthermore, differential drivers such as, for example, LVDS (Low Voltage Differential Signaling) such as, for example, JESD96 are used for many interface units.

### BACKGROUND

In the production of an integrated circuit having a differential driver in accordance with an LVDS interface, there is the problem that driver devices of this type reliably comply with a characteristic quantity defined in a so-called eye diagram. For this purpose, it is necessary to provide test apparatuses which monitor driver units of this type with regard to specific parameters such as transmission amplitude, transmission frequency and edge steepness.

By way of example, the LVDS (Low Voltage Differential Signaling) interface standard is provided for high-speed data transmission. LVDS is standardized according to AMSI/TIA/PIA-644-1995. The essential features of LVDS are differential voltage levels and relatively low voltage values. In this case, differential signal transmission is effected by using two lines and by employing the difference between the voltages for the logic state. In the case of LVDS, the voltage difference is usually 0.3 volt, while an absolute voltage is provided at approximately 1.2 volts. A logic change is brought about by a polarity reversal of the lines. In the case of such symmetrical signal transmission, the signals on the two lines are always opposite.

The two lines (paths) are usually arranged closely adjacent to one another in order to ensure low interference emission. The line impedance over the entire transmission link including possible plug connections is essentially constant. Transmission links of this type are also used in the Gbit/s range. In this case, the two line lengths have to be designed to be exactly identical in order to avoid propagation time differences. A major problem in such LVDS signal transmission at very high data transmission rates is that the functionality of a driver unit has to be checked.

### SUMMARY OF THE INVENTION

The present invention provides a test apparatus for testing circuit units to be tested which enables an efficient and cost-effective testing of rapid operations in the circuit units to be tested.

One aspect of the invention consists in dividing the test apparatus into two test devices, a first test device being arranged outside the circuit unit to be tested and a second test device being arranged integrally with the circuit unit to be tested. A test result signal output from the second test device is fed to the first test device.

A further aspect of the invention consists in providing a circuit unit having a sample-and-hold unit for sampling at least one voltage value of an output signal output from the circuit unit to be tested and for holding the sampled voltage value. In this case, a logic unit arranged in the circuit unit to be tested drives the sample-and-hold circuit, the voltage values sampled by means of the second test device being output as a test result signal.

### BRIEF DESCRIPTION OF THE DRAWINGS

Exemplary embodiments of the invention are illustrated in the drawings and are explained in more detail in the description below.

In the drawings:

FIG. 1 shows an eye diagram formed for the analysis of an output signal from a circuit unit to be tested and serving for ascertaining the functionality of the circuit unit to be tested;

FIG. 2a shows a block diagram illustrating the essential blocks of the test apparatus, which are arranged on the one hand in the circuit unit to be tested and on the other hand externally of the circuit unit to be tested, for an understanding of the principles of the present invention;

FIG. 2b shows a detailed block diagram of the circuit unit to be tested comprising a test device arranged integrally with the circuit unit to be tested and a test device arranged outside the circuit unit to be tested, in accordance with one preferred exemplary embodiment of the present invention;

FIG. 3 shows an embodiment according to the invention of the logic unit which is contained in that test device which is arranged within the circuit unit to be tested;

FIG. 4 shows a flowchart for illustrating sample-and-hold signals and an output differential signal of the circuit unit to be tested, for elucidating the function of the logic unit illustrated in FIG. 3;

FIG. 5 shows a further logic unit, which is arranged in that test device which is formed integrally with the circuit unit to be tested, in accordance with a further preferred exemplary embodiment of the present invention;

FIG. 6 shows a test apparatus in which that test device which is arranged integrally with the circuit unit to be tested is varied by comparison with the exemplary embodiment shown in FIG. 2b; and

FIG. 7 shows a test apparatus in which a finite automaton is provided within that test device which is arranged integrally with the circuit unit to be tested, in accordance with a further preferred exemplary embodiment of the present invention.

In the figures, identical reference symbols designate identical or functionally identical components or steps.

### DESCRIPTION OF THE INVENTION

Exemplary embodiments of the present invention are described in greater detail below.

One aspect of the present invention provides a test apparatus for testing circuit units to be tested, which essentially comprises:

a) a first test device, which is arranged outside the circuit unit to be tested;

b) a second test device, which is arranged integrally with the circuit unit to be tested;

c) a sample-and-hold unit arranged in the second test device and serving for sampling at least one voltage value of an output signal output from the circuit unit to be tested and for holding the sampled voltage value; and

d) a logic unit for driving the sample-and-hold unit, the voltage value sampled by means of the second test device being fed as a test result signal to the first test device.

One essential advantage of the present invention consists in the fact that the second test device is formed as a unit with the circuit unit to be tested. The second test device preferably has a sample-and-hold unit for sampling at least one voltage value of an output signal output from the circuit unit to be tested and for holding the sampled voltage value. In this case, a logic unit arranged in the circuit unit to be tested drives the sample-and-hold circuit, the voltage value sampled by means of the second test device being output as a test result signal and being fed to the first test device.

Consequently, the test apparatus according to the invention has the advantage that the integration of an internal test circuit reduces requirements made of external test devices in such a way that a complete test cycle including the logic part and the LVDS driver part of the circuit unit to be tested can proceed on an inexpensive logic tester, without test times being lengthened, test accuracies being reduced or a chip area consumption being appreciably increased. This affords the advantage that the test costs are considerably reduced.

Furthermore, the method according to the invention for testing circuit units to be tested essentially has the following steps:

a) connection of the circuit unit to be tested, which has a second test device formed integrally therewith, to a first test device, which is arranged outside the circuit unit to be tested;

b) sampling, by means of a sample-and-hold unit arranged in the second test device, of at least one voltage value of an output signal output from the circuit unit to be tested;

c) driving of the sample-and-hold unit by means of a logic unit arranged in the second test device;

d) holding of the sampled voltage value by means of the sample-and-hold unit; and

e) outputting of the voltage value sampled by means of the second test device as a test result signal and feeding of the test result signal to the first test device.

The invention furthermore provides a circuit unit which can be tested by means of a test apparatus, comprising:
a) a second test device, which is arranged integrally in the circuit unit to be tested and which has:
a1) a sample-and-hold unit for sampling at least one voltage value of an output signal output from the circuit unit (101) to be tested and for holding the sampled voltage value; and
a2) a logic unit for driving the sample-and-hold unit,
b) the voltage value sampled by means of the second test device being output as a test result signal.

In accordance with one preferred development of the present invention, the first and second test devices are designed in such a way that the first test device is designed principally for detecting low-frequency signals, while the second test device is designed principally for detecting high-frequency or highly transient signals.

In accordance with a further preferred development of the present invention, the logic unit has a test pattern generator for generating a test pattern data stream. The test pattern data stream is fed to the circuit unit to be tested and serves for testing the circuit unit to be tested.

In accordance with yet another preferred development of the present invention, the logic unit has a delay device for generating the sample-and-hold signal from a clock input signal fed to the circuit unit to be tested.

In accordance with yet another preferred development of the present invention, the logic unit has a ring oscillator for generating the sample-and-hold signal from a clock input signal fed to the circuit unit to be tested.

In accordance with yet another preferred development of the present invention, the circuit unit to be tested is tested by means of periodic zero-one sequences in the second test device.

Preferably, an analysis of the test result signal is affected by means of an eye opening of an eye diagram in the second test device.

In this way, the test apparatus for testing circuit units to be tested and the associated method make it possible to achieve the present invention.

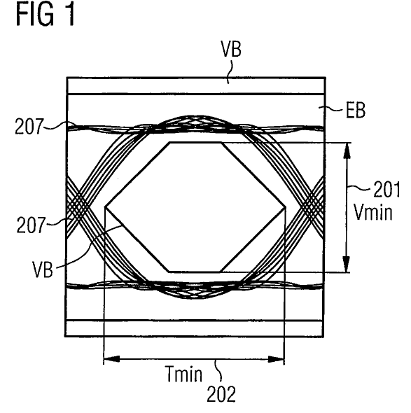

In order to be able to assess the functionality of a circuit unit to be tested, an eye diagram shown in FIG. 1 is employed. An eye diagram of this type corresponds to a representation of output differential signals that are output from the circuit unit to be tested or a high-frequency driver device arranged in the latter. In this case, a light region EB illustrated in FIG. 1 corresponds to an “allowed band”, while regions VB illustrated as dark correspond to “forbidden bands”.

Consequently, in order to ensure a functionality of a circuit unit to be tested, an output differential signal identified by the reference symbol 207 must be in the allowed band EB. Typically, a minimum transmission amplitude is |Vₘᵢₙ|>100 mV_{PP}. An amplitude of this type is identified by the reference symbol 201 in FIG. 1.

The edge steepness of the output differential signal 207 determines the minimum eye opening 202. A minimum eye opening of Tₘᵢₙ>55%*1/(2*f_{Clock}) is required in this case. At a typical clock frequency of 156 MHz, an eye opening 202 of Tₘᵢₙ>1.76 nanoseconds (ns) results in this case.

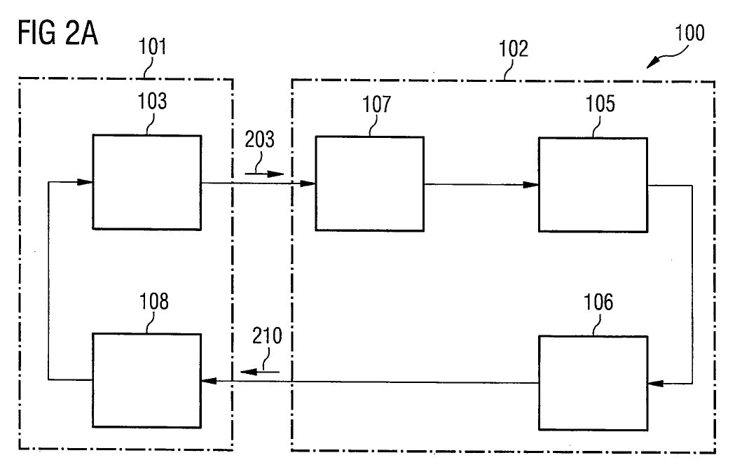

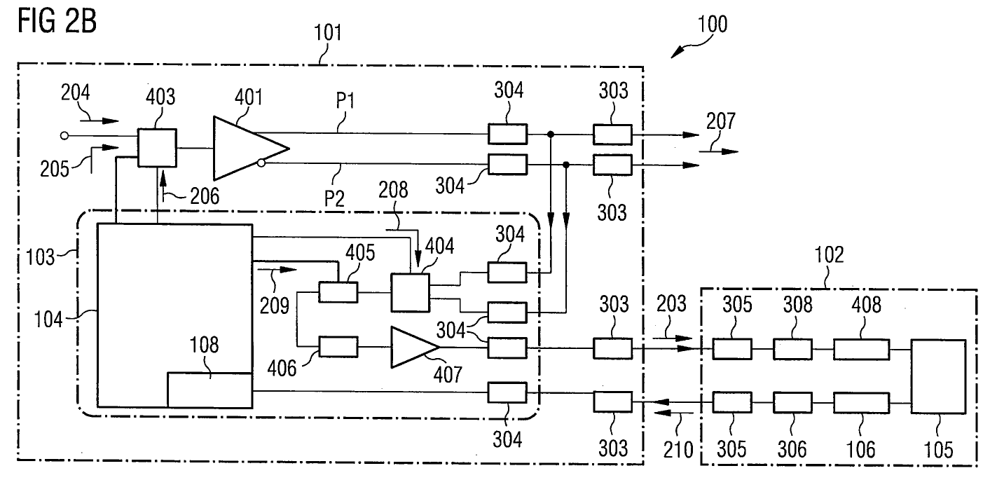

FIG. 2a illustrates a block diagram for elucidating the principles of the present invention. FIG. 2a illustrates a circuit unit 101 to be tested and a first test device 102, which form the test apparatus 100. Signals are exchanged between the circuit unit 101 to be tested and the first test device 102, i.e. a test control signal 210 from the first test device 102 to the circuit unit 101 to be tested and a test result signal 203 from the circuit unit 101 to be tested to the first test device 102. According to the invention, the circuit unit 101 to be tested has a control interface unit 108, which can communicate with a controller unit 106 of the first test device 102.

Furthermore, the circuit unit 101 to be tested has a second test device 103, which carries out a test with regard to highly transient operations in the circuit unit 101 to be tested. A test implementation of this type is described in detail below.

The result of this test is fed as the test result signal 203 to a tester input circuit 107 arranged in the first test device 102. The tester input circuit 107 has, inter alia, a memory unit for storing the test result signal 203. The tester input circuit 107 is furthermore connected to an analysis and control device 105, which is arranged in the first test device 102 and which controls an entire test sequence. Thus, the analysis and control device 105 also controls a data exchange between the controller unit 106 and the control interface unit 108 of the circuit unit 101 to be tested.

In this case, the first test device 102 and the second test device 103 have different properties, in such a way that the first test device 102 is designed for detecting low-frequency signals, while the second test device, which is arranged integrally with the circuit unit 101 to be tested, is designed for detecting and for testing high-frequency or highly transient signals.

In this way, the first test device 102 can be designed in a simple and cost-effective manner. The functioning of the second test device 103 will be explained below with reference to FIGS. 2b to 7.

FIG. 2b shows a detailed block diagram of a test apparatus in accordance with one preferred exemplary embodiment of the present invention. It should be pointed out that, for reasons of simplification, technical circuit details such as terminating resistors, load impedances, etc. have been omitted in the following figures since they do not make any contribution to an understanding of the present invention.

As shown in FIG. 2b, the test apparatus 100 according to the invention is divided into a first test device 102 (right-hand dashed block in FIG. 2b) and a second test device 103 (dashed block within the circuit unit 101 to be tested). Testing of a high-speed driver represented by the transmission unit 401 is illustrated in the preferred exemplary embodiment of the present invention.

It should be pointed out, however, that the test apparatus according to the invention is not restricted to testing of high-speed drivers. The test apparatus according to the invention can advantageously be used for testing circuit units 101 to be tested which have signals having fast transitions.

The transmission unit 401 of the circuit unit 101 to be tested outputs a differential signal on two paths P1 and P2. The signal provided by the transmission unit 401 is fed as an output differential signal 207 to further circuit units (not shown). The output differential signal 207 is employed for checking the functionality of the circuit unit 101 to be tested. A discharge protection unit, ESD (ESD=Electrostatic Discharge) 304 and a connection unit 303 are arranged in series in each of the two differential output paths P1, P2 of the circuit unit 101 to be tested. The discharge protection units 304 protect the entire circuit arrangement against overvoltages or transient voltage pulses. The connection units 303 serve for connecting the circuit unit to be tested to external circuit units.

As is furthermore illustrated in FIG. 2b, an input multiplexer unit 403 is connected upstream of the transmission unit 401, and changes over between a test pattern data stream 205 and the input data stream 204 in a manner dependent on the feeding of a test selection signal 206. In a test operating mode, the test pattern data stream 205 for testing the transmission unit or the assigned high-speed driver units is conducted through the input multiplexer unit 403.

As is shown in FIG. 2b, the second test device 103 comprises the logic unit 104, which has the control interface unit 108 for communication with the first test device 102. The second test device 103 furthermore comprises circuit components for sampling the output differential signal 207. For this purpose, the output differential signal is tapped off at the output of the circuit unit 101 to be tested and forwarded by discharge protection units 304 to a path multiplexer unit 404. The path multiplexer unit 404 serves for changing over between the individual differential paths P1 and P2 in a manner dependent on a fed path selection signal 208.

The path selection signal 208 is generated, in the same way as the test selection signal 206, in the logic unit 104, which is described in greater detail below. Consequently, either the path P1 or the path P2 is switched through by the path multiplexer unit 404, the corresponding differential portion of the output differential signal 207 being ready at the output of the path multiplexer unit 404. The output of the path multiplexer unit 404 is connected to a sample-and-hold unit 405, which is driven by a sample-and-hold signal 209.

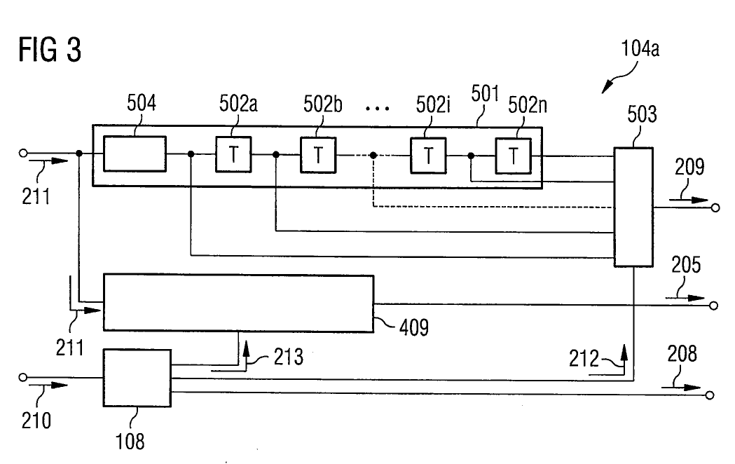

The generation of the sample-and-hold signal 209 will be explained in greater detail below with reference to FIGS. 3 to 7. It should merely be noted at this juncture that the sample-and-hold unit 405, at specific, fixedly prescribed instants, samples samples of the corresponding part of the output differential signal 207, which is prescribed by the path multiplexer unit 404, and holds a corresponding voltage value.

The sample-and-hold unit 405 samples at least one voltage value of the differential output signal 207 output from the circuit unit 101 to be tested and holds the sampled voltage value. In this case, it is possible “on chip” i.e. on the circuit unit 101 to be tested, already to perform a preprocessing of the highly transient signals, so that afterward only a low-frequency or DC voltage signal has to be output from the second test device 103, which is arranged within the circuit unit 101 to be tested, to the first test device 102 arranged externally.

A filter unit 406 is arranged such that it follows the sample-and-hold unit 405, a filtering of the signal output from the sample-and-hold unit 405 being performed by means of the filter unit. The filter unit 406 is followed by an amplifier unit 407 for amplifying the voltage signal output from the filter unit 406. The amplified voltage signal is output as a test result signal 203 toward the outside via a discharge protection unit 304 and a connection unit 303 of the circuit unit 101 to be tested.

One essential advantage of the present invention consists in the fact that the first test device 102 (right-hand dashed block in FIG. 2b) can be configured significantly more simply and more cost-effectively as a result of the preprocessing in the second test device 103. In particular, it is no longer necessary for the first test device 102 to process highly transient or high-frequency signals. At its input side, the first test device 102 has a probe unit 305, which takes up the test result signal 203 output from the circuit unit 101 to be tested. An analog-to-digital converter 308 for converting the output voltage signal is arranged such that it follows the probe unit 305.

After analog-to-digital conversion of the test result signal 203 in the analog-to-digital converter 308, the digital value then obtained is fed to a memory unit 408, in which the test result signal 203 is stored as a digital value. This is followed, with the aid of the analysis and control device 105, by an analysis of the test result and a determination of whether or not the circuit unit 101 to be tested is free of faults in its entirety. In particular, such an ascertainment is also performed on the basis of an evaluation of the eye diagram shown in FIG. 1.

The analysis and control device 105 arranged in the first test device 102 furthermore serves for providing a test control signal 210 for controlling the second test device 103. For this purpose, the first test device 102 has a controller unit 106, which is driven by means of the analysis and control device 105. An output signal of the controller unit 106 is output from the first test device 102 via a driver unit 306 and a probe unit 305 and fed to a further connection unit 303 of the circuit unit 101 to be tested.

For protection against electrostatic discharges, a discharge protection unit 304 is once again connected downstream of the connection unit 303. The test control signal 210 is finally fed to the abovementioned control interface unit 108 of the logic unit 104. The control of a test when testing the circuit unit 101 to be tested by means of the test control signal 210 is explained in greater detail below.

It should be pointed out that, in the exemplary embodiment shown in FIG. 2b, the transmission unit 401 forms an output differential signal 207 from a “single-ended” input signal. In a normal operating mode, the received data stream 204 is fed via the input multiplexer unit 403 to the transmission unit 401, which outputs the output differential signal 207 via the two paths P1 and P2. However, the present invention is not restricted to the use of differential output signals.

The control interface unit 108 may be formed for example as a serial bus, a digital interface such as, for example, a JEDEC bus or as a parallel interface. The second test device 103 arranged integrally in the circuit unit 101 to be tested therefore carries out a sampling of highly transient signals by the sample-and-hold method and provides a low-frequency test result signal 203. The test pattern data stream 205 that is output from the logic unit 104 of the second test device 103 and fed to the transmission unit 401 via the input multiplexer unit 403 may comprise a simple sequence of logic zero and logic one.

A 0-1-0 . . . bit stream of this type is eminently suitable for testing the circuit unit to be tested with regard to highly transient operations. Whilst employing the eye diagram shown in FIG. 1, a test pattern of this type is then settled, for example 24 sampling points being used. In the case of 24 sampling points, ten sampling points, for example, must be at logic “0”, while at least ten sampling points that are different therefrom must produce a logic “1” signal, in order to be able to ascertain an entirely satisfactory function of the circuit unit 101 to be tested.

The sampling of high-frequency or highly transient signals which is carried out according to the sample-and-hold method by means of the sample-and-hold unit 405 is based on the fact that the test pattern data stream 205 is periodic. Such a periodic test pattern data stream 206 is advantageously generated in the second test device 103 arranged within the circuit unit 101 to be tested and is in turn ready for the testing of the circuit unit 101 to be tested.

It should be pointed out that in the subsequent figures relating to circuit arrangements, terminating resistors, load impedances and other details which are unimportant for an understanding of the invention have been omitted for reasons of simplification.

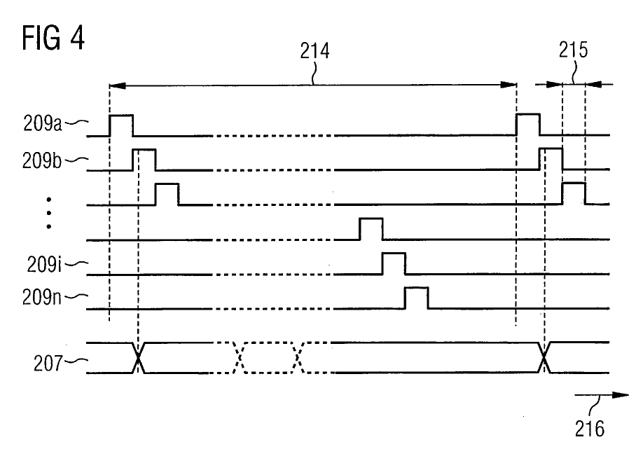

FIG. 3 shows a preferred embodiment of the logic unit 104 illustrated in FIG. 2b. The variant of the logic unit 104a that is shown in FIG. 4 has a delay device 501 as a central element, the delay device being formed from individual delay units 502a-502n (T). A clock input signal 211 fed to the logic unit is firstly fed to a pulse generating unit 504 of the delay device 501.

After the generation of an output pulse, which is explained in more detail below with reference to FIG. 4, the pulse is fed sequentially to the delay units 502a-502n of the delay device 501. It should be pointed out that the delay units 502a-502n may in each case provide the same delay T of the pulse signal output from the pulse generating unit 504 or a different delay.

FIG. 3 is based on the assumption that the delay units 502a-502n provide identical time delays T of the pulse signal. The outputs of the individual delay units 502a-502n are fed to a changeover unit 503, which may be formed as a multiplexer. In a manner dependent on a changeover signal 212 fed to the changeover unit 503, a time-delayed pulse signal is in each case output as the sample-and-hold signal 209. Consequently, it is possible, with the sample-and-hold signal 209 thus generated, to sample a highly transient signal in a manner similar to that in the case of a sample-and-hold oscilloscope within the circuit unit 101 to be tested.

The logic unit 104a shown in FIG. 3 furthermore has a test pattern generator 409, which provides the test pattern data stream (a periodic test signal) 205.

For this purpose, the clock input signal 211 is fed to the test pattern generator 409. The test control signal 210 output from the first test device 102 is furthermore fed to the logic unit 104a via the abovementioned interface unit 108, the test control signal being employed for the control of the entire logic unit 104a.

The control interface unit 108 thus outputs a drive signal 213 to the test pattern generator 409 in a manner dependent on the fed test control signal 210, the test pattern generator providing the test pattern data stream 205 as a periodic test signal in a manner dependent on the drive signal 213 and the fed clock signal 211.

The path selection signal, which was explained above with reference to FIG. 2b and serves for defining a path P1, P2 to be sampled, is furthermore output from the control interface unit 108. Consequently, the logic unit 104a illustrated in FIG. 3 supplies, in a manner dependent on the fed clock input signal 211 and the test control signal 210 provided by the first test device 102, three output signals for controlling a test of the circuit unit to be tested with the aid of an integrally arranged test device, i.e. the second test device 103: the sample-and-hold signal 209, the periodic test pattern data stream 205 and the path selection signal 208.

FIG. 4 illustrates the sample-and-hold signal 209 in relation to the output differential signal 207 on a common time axis 216. As illustrated in FIG. 4, a sampling period 214 is defined by the periodically occurring pulses which are output from the pulse generating unit 504 (FIG. 3). In this case, a pulse width of the pulse signal output from the pulse generating unit 504 defines the sampling time.

As already explained above with reference to FIG. 3, individual sample-and-hold signals 209a-209n in each case have a time delay by T with respect to one another. This is represented by the time profiles 209a-209n in FIG. 4. The changeover unit 503 illustrated in FIG. 3 then selects one of the sample-and-hold signals in a manner dependent on the fed changeover signal 212 in order to periodically sample the output differential signal or a path P1, P2 of the output differential signal.

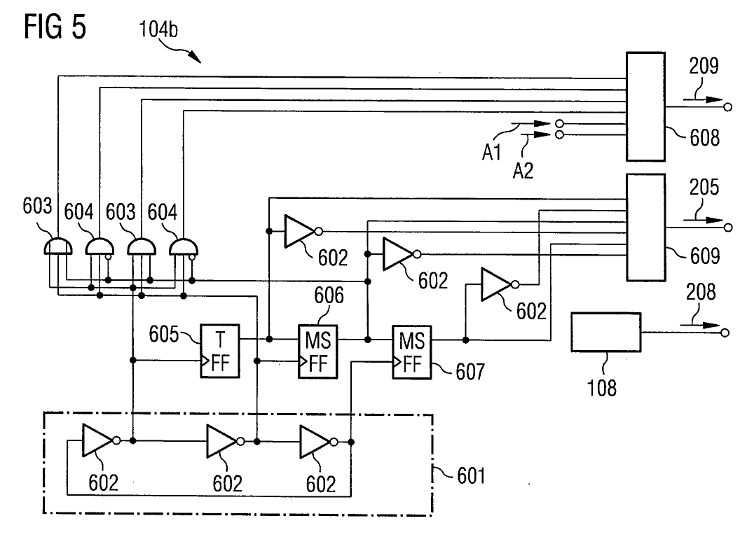

FIG. 5 illustrates a further variant of the logic unit 104 of the second test device 103 that is illustrated in FIG. 2b. The logic unit 104b illustrated in FIG. 5 has a first multiplexer unit 608 and a second multiplexer unit 609.

The first multiplexer unit 608 is employed for generating the sample-and-hold signal 209, while the second multiplexer unit 609 is employed for generating the test pattern data stream 205. A central element of the logic unit 104b illustrated in FIG. 5 is a ring oscillator 601 formed from individual inverter units 602. In interaction with a T flip-flop 605, a first master-slave flip-flop 606 and a second master-slave flip-flop 607, test pattern data streams 205 are obtained from the output signals of the inverter units 602 arranged in the ring oscillator 601. The logic unit 104b furthermore has a control interface unit 108 for outputting the path selection signal 208.

Furthermore, the output signals of the first inverter unit 602 of the ring oscillator 601, of the T flip-flop 605 and of the first master-slave flip-flop 606, as shown in FIG. 5, are combined by means of first and second gate units 603, 604 in such a way that the output signals of the first and second gate units 603, 604, after being conducted through the first multiplexer unit 608, provide the sample-and-hold signal 209. The selection signals A1 and A2, which are likewise fed to the first multiplexer unit 608, serve for changeover between the individual sample-and-hold signals 209.

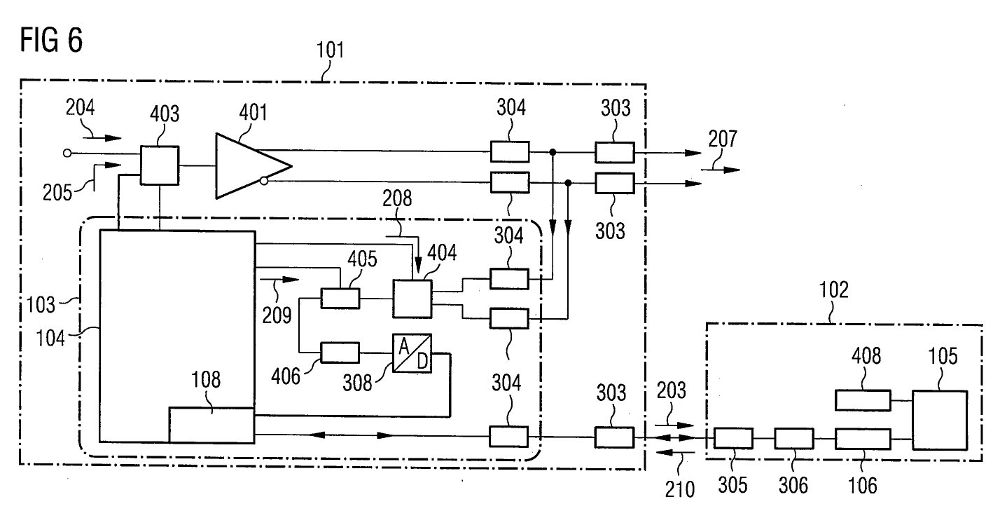

FIG. 6 illustrates a further preferred embodiment of the present invention, in which modifications are provided by comparison with the first embodiment shown in FIG. 2b.

In order to simplify the description, only those parts that have been altered by comparison with the embodiment illustrated in FIG. 2b are discussed below. An essential difference between the embodiment of FIG. 6 and the embodiment of FIG. 2b is that an analog-to-digital converter 308 is not provided in the first test device 102, but rather in the second test device 103.

Such a circuit design may be advantageous when the circuit unit 101 to be tested already has an analog-to-digital converter which can be employed for digitizing the signal output from the filter unit 406. The digitized output value of the analog-to-digital converter 308 is subsequently fed to the control interface unit 108, which outputs the test result signal 203 (here as a digital signal) to the first test device 102 via the circuit units arranged in the circuit device 101 to be tested, i.e. the discharge protection unit 304 and the connection unit 303.

The embodiment of the present invention that is illustrated in FIG. 6 has the advantage that the first test device 102 is now simplified further. The first test device 102 here has only a single input connection comprising a bidirectional probe unit 305 and a bidirectional driver unit 306. The controller unit 106 serves for data exchange with the control interface unit 108 of the second test device 103. Via a single line connection between the first test device 102 and the circuit unit 101 to be tested, it is then the case that the test result signal 203 is fed to the first test device 102 and that the test control signal 210 is fed to the second test device 103.

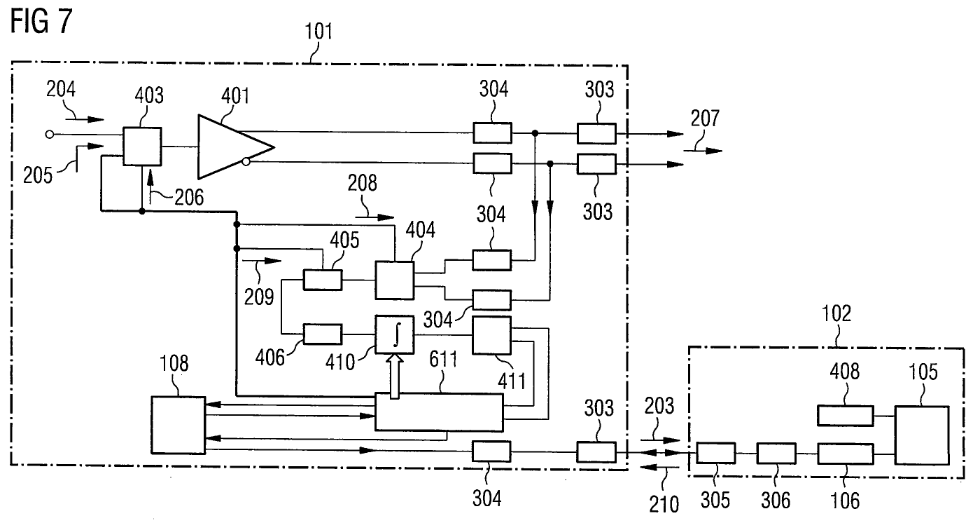

FIG. 7 shows a further preferred exemplary embodiment of the present invention, in which the logic unit is replaced by a combination of a data bus unit 610 with a finite automaton 611.

The finite automaton 611 is designed as a state machine that provides a corresponding output depending on input actions. In this way, it is possible to generate the signals already described with reference to FIG. 2b, i.e. the test selection signal 206, the test pattern data stream 205 and the sample-and-hold signal 209. In addition to the circuit components described in the previous embodiments, the circuit unit 101 to be tested that is illustrated in FIG. 7 furthermore has an integration unit 410 and a comparator unit 411 connected downstream of the integration unit 410. In this case, the output signal of the filter unit 406 is fed to the integration unit 410, the output signal being integrated in a manner dependent on start and end instants that are prescribed by the finite automaton 611. An over- or undershooting of specific output voltage values that are output from the integration unit 410 is ascertained by the comparator unit 411.

Although the present invention has been described above on the basis of preferred exemplary embodiments, it is not restricted thereto, but rather can be modified in manifold ways.

Moreover, the invention is not restricted to the application possibilities mentioned.

What is claimed is:

1. A test apparatus for testing a circuit unit, comprising:
a) a first test device, which is arranged outside the circuit unit; and
b) a second test device, which is arranged integrally with the circuit unit;
wherein the second test device comprises:
b1) a sample-and-hold unit configured to sample at least one voltage value of an output signal output from the circuit unit and to hold the sampled voltage value; and
b2) a logic unit configured to drive the sample-and-hold unit,
wherein the voltage value is sampled by means of the second test device being fed as a test result signal to the first test device.

2. The test apparatus as claimed in claim 1, wherein the first test device is configured to detect low-frequency signals.

3. The test apparatus as claimed in claim 1, wherein the second test device is configured to detect high-frequency signals.

4. The test apparatus as claimed in claim 1, wherein the logic unit has a test pattern generator configured to generate a test pattern data stream with which the circuit unit can be tested.

5. The test apparatus as claimed in claim 1, wherein the logic unit has a delay device configured to generate the sample-and-hold signal from a clock input signal fed to the circuit unit.

6. The test apparatus as claimed in claim 1, wherein the logic unit has a ring oscillator configured to generate the sample-and-hold signal from a clock input signal fed to the circuit unit.

7. The test apparatus as claimed in claim 1, wherein the second test device further comprises an analog-to-digital converter for outputting a digital signal to the logic unit.

8. A method for testing a circuit unit, comprising:
a) connecting the circuit unit, which has a second test device formed integrally therewith, to a first test device, which is arranged outside the circuit unit;
b) sampling, by means of a sample-and-hold unit arranged in the second test device, at least one voltage value of an output signal output from the circuit unit;
c) driving the sample-and-hold unit by means of a logic unit arranged in the second test device;
d) holding the sampled voltage value by means of the sample-and-hold unit; and
e) outputting the voltage value sampled by means of the second test device as a test result signal and providing the test result signal for the first test device.

9. The method as claimed in claim 8, wherein a high-frequency test cycle is carried out completely in the second test device.

10. The method as claimed in claim 9, wherein the high-frequency test cycle is carried out using a sample-and-hold process.

11. The method as claimed in claim 8, wherein the circuit unit is tested using periodic zero-one sequences generated in the second test device.

12. The method as claimed in claim 8, wherein an analysis of the test result signal is carried out using an eye opening of an eye diagram in the second test device.

13. A circuit unit which can be tested by a test apparatus, comprising:
a second test device, which is arranged integrally in the circuit unit, wherein the second test device comprises:
a sample-and-hold unit configured to sample at least one voltage value of an output signal output from the circuit unit and to hold the sampled voltage value; and
a logic unit configured to drive the sample-and-hold unit,
wherein the voltage value sampled by the second test device is output as a test result signal.

14. The circuit unit as claimed in claim 13, wherein the test result signal output from the second test device is fed to a first test device.

15. The circuit unit as claimed in claim 14, wherein the first test device is configured to detect low-frequency signals.

16. The circuit unit as claimed in claim 13, wherein the second test device is configured to detect high-frequency signals.

17. The circuit unit as claimed in claim 13, wherein the logic unit has a test pattern generator configured to generate a test pattern data stream with which the circuit unit an be tested.

18. The circuit unit as claimed in claim 13, wherein the logic unit has a delay device configured to generate the sample-and-hold signal from a clock input signal fed to the circuit unit.

19. The circuit unit as claimed in claim 13, wherein the logic unit has a ring oscillator configured to generate the sample-and-hold signal from a clock input signal fed to the circuit unit.

20. A test apparatus for testing a circuit unit, comprising:
a) a first test device, which is arranged outside the circuit unit; and
b) a second test device, which is arranged integrally with the circuit unit;
wherein the second test device comprises:
b1) a sample-and-hold unit configured to sample at least one voltage value of an output signal output from the circuit unit and to hold the sampled voltage value; and
b2) a data bus unit and a finite automaton configured to drive the sample-and-hold unit,
wherein the voltage value is sampled by means of the second test device being fed as a test result signal to the first test device.

21. A circuit unit which can be tested by a test apparatus, comprising:
a second test device, which is arranged integrally in the circuit unit, wherein the second test device comprises:
a sample-and-hold unit configured to sample at least one voltage value of an output signal output from the circuit unit and to hold the sampled voltage value; and
a logic means for driving the sample-and-hold unit,
wherein the voltage value sampled by the second test device is output as a test result signal.

22. A test apparatus for testing a circuit unit, comprising:
a) a first test means, which is arranged outside the circuit unit, for detecting low-frequency signals; and
b) a second test means, which is arranged integrally with the circuit unit, for detecting high-frequency signals;
wherein the second test means comprises:
b1) a sample-and-hold unit configured to sample at least one voltage value of an output signal output from the circuit unit and to hold the sampled voltage value; and
b2) a logic means for driving the sample-and-hold unit,
wherein the voltage value is sampled by means of the second test means being fed as a test result signal to the first test means.
